(19) United States
(12) Patent Application Publication
(10) Pub. No.: US 2005/0028152 A1
(43) Pub. Date: Feb. 3, 2005

(54) Method and apparatus for identifying a Java class package name without disassembling Java bytecodes

(75) Inventors: Douglas Earl Hays, Nicholasville, KY (US); Sachin Pravin Patel, Raleigh, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/632,569

(22) Filed: Aug. 1, 2003

(51) Int. Cl. G06F 9/44

(52) U.S. Cl. 717/166; 717/116; 717/118

(57) ABSTRACT

A system and method for retrieving class package name from a class file if not known or found by the Java class loader of the Java virtual machine at load time. An algorithm is derived which uses the class file to obtain the class package name by iterating the directory names of the class file in the user's current operating system. An output is provided to the user when the class package name is found and it is loaded by the Java class loader; when an error occurs after which the error message indicates that the prerequisite class of the class file is missing; or when the class package name itself is invalid.

### BACKGROUND OF THE INVENTION

1. Technical Field

The present invention relates generally to an improved data processing system and in particular to the Java class loader in the Java virtual machine. Still more particularly, the present invention provides a method, apparatus, and computer instructions to identify a Java class package name without having to disassemble bytecodes in the class file.

2. Description of Related Art

In recent days, the Java architecture introduced by Sun Microsystems, Inc. has become increasingly popular in the use of software development. This increased popularity is partly due to its advantages in the architecture to accommodate problems such as a variety of network-centric hardware platforms and security issues when sending files across networks. The Java architecture consists of two major components: the Java virtual machine, known as the JVM and the Java application programming interface, known as the Java API. It is in the Java virtual machine that the problems of portability, ability to run a program in any hardware or software platform, and security issues associated with sending files across networks are solved.

The JVM is an abstract computing machine. Like a real computing machine, the JVM has an instruction set and manipulates various memory areas at run time. The JVM does not assume any particular implementation technology, host hardware, or host operating system. A JVM is not inherently interpreted, but can just as well be implemented by compiling its instruction set to that of a silicon central processing unit. Further, a JVM also may be implemented in microcode or directly in silicon.

A JVM works in the Java platform as follows: a program file with a “.java” extension is first compiled by the compiler to translate it into Java bytecodes. Java bytecodes are platform independent codes interpreted by the interpreter on the Java platform. The Java bytecodes are in binary format stored in a class file. The interpreter then parses and runs the Java bytecode instructions on the computer. In turn, the program is only compiled once and interpreted each time the program is executed. The use of Java bytecodes helps to make “write once, run anywhere” possible.

The second component of the Java platform is the Java application programming interface (API). This API is a collection of software components that provide many capabilities, such as a graphical user interface (GUI) widgets. The Java API is grouped into libraries of related classes and interfaces called packages. Programmers primarily use the Java API to write the program. The Java API acts as an interface between the program written by the programmer and the JVM, which executes the program in a hardware-based platform by interpreting the Java bytecodes corresponding to the program. These two features enable platform independence by using Java bytecodes that access system resources of the underlying operating system through the Java API.

A typical way a program runs in the Java architecture is the JVM first loads the class file that is compiled from the program and the Java API. This loading of the class file is accomplished by a mechanism inside the JVM called a “class loader”. Only those class files that are needed by the running program are loaded into the JVM. Next, the bytecodes are executed in an execution engine. Normally, the bytecodes are interpreted by the engine one at a time.

A class loader may be a subsystem of multiple class loaders. A Java application may have two types of class loaders: a bootstrap class loader and user-defined class loader objects. A bootstrap class loader is, for example, part of the C program if the JVM is implemented as a C program on top of an operating system. Bootstrap class loader normally loads from the local disk. At runtime, the JVM considers any class it loads from the bootstrap class loader trusted, as opposed to any class it loads from the class loader objects as suspicion. The bootstrap class loader is part of the JVM implementation, but the user-defined class loader objects are not. User-defined class loader objects are objects written in Java programming language, compiled to class files, loaded into the JVM and instantiated just like any other object. Due to its nature, a running application can determine at runtime what extra classes it needs and loads them through the user-defined class loader objects. Therefore, user-defined class loader objects, as derived from its name, can be from other sources such as across the network or from a database as defined by the user.

When the JVM loads a class, the JVM keeps track of which type of class loader loaded the class. If a loaded class refers to another class, the JVM first looks at the same class loader for the referenced class. Then the referenced class is dynamically linked to the loaded class. By default all the classes in the same class loader can see each other, therefore, the Java architecture allows multiple namespaces, also known as packages in the Java programming language, inside a single Java application, for example, com.ejb.Bean. Since classes loaded by different class loaders are in different namespaces or packages, therefore they cannot access each other unless the application explicitly imports that namespace or package. This mechanism provides an advantage for the user to minimize interaction between code loaded from different sources, also known as information hiding. This feature enables the Java architecture to solve the security issues by loading classes from different sources through different user-defined class loaders.

As discussed above, a class is loaded at runtime by a calling Java application if the class is needed. Currently, if the requisite class is not found in the same namespace or package and no classpath is set by the user to find that namespace or package, a NoClassDefFoundError is thrown by the application, and the application exits. In cases when user does not know the package name or the user enters the package name incorrectly, this situation becomes a problem. One way to solve this problem is by disassembling the Java bytecodes to find the class package name, but this method is too difficult and time consuming for any person of ordinary skill in the art to perform. Ethical and legal issues arise from reverse engineering a software without approval. Therefore, it would be advantageous to have an improved method, apparatus and computer instructions for determining the correct class package name without having to disassemble bytecodes or reverse engineer software.

### SUMMARY OF THE INVENTION

The present invention provides a method, apparatus, and computer instructions for identifying a class package name from a class file if the class package name is not known or found at load time by the Java class loader of the Java virtual machine (JVM). Responsive to a selection of a class file, a path is identified for the class file. This path is parsed to identify segments, which includes directory names of the class file. The package name is ascertained from the segments without requiring disassembly of the class file.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system is shown in which the present invention may be implemented;

FIG. 3 is a diagram illustrating components used in identifying a class package name for a class file in accordance with a preferred embodiment of the present invention;

FIG. 4 is a diagram illustrating a process used to parse a path for a class file into segments in accordance with a preferred embodiment of the present invention; and

FIG. 5 is a flowchart of a process for identifying a class package name in accordance with a preferred embodiment of the present invention.

### DETAILED DESCRIPTION OF THE PREFERRED EMBODIMENT

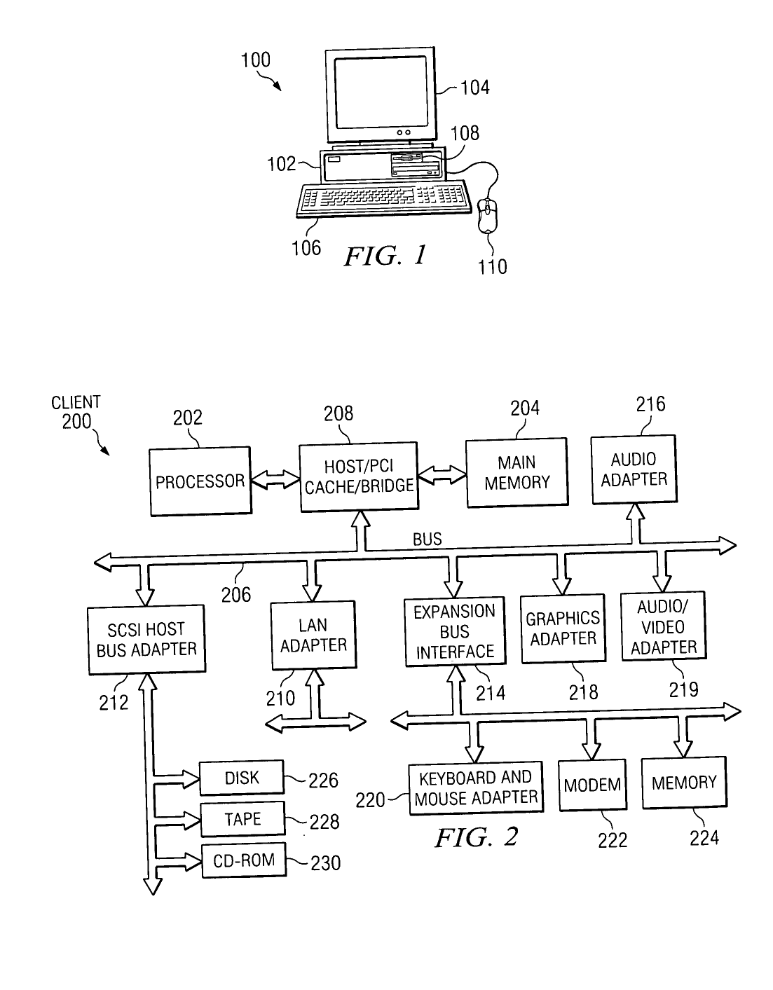

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention provides a method, apparatus, and computer instructions for identifying a class package name of a class file. The mechanism of the present invention is employed to retrieve a class package name from a class file if the class package name is not known or found by the Java class loader of the Java virtual machine. This situation may occur when a user “drag and drops” a class file for use. A class file can be obtained in various file formats from the user. For example, a zip or jar file format. The class file may reside in the hard disk drive of a data processing system as described above or the class file may be accessed remotely from a communication network through a network communication interface of the above data processing system.

Typically, when a user runs a Java application that requires a class file (for example, the IBM WebSphere Application Assembly Tool for WebSphere Application Server or the WebSphere Studio Application Developer, which are available from IBM), the Java class loader tries to load the class file in the same directory where the class file is located or where the classpath is set. However, a user may identify the class file to be used by the application from a directory different from the location used by the class loader. For example, a user may “drag and drop” a class file from a directory with only the class file's relative directory path identified. This situation requires the user to know the class package name to locate the class file. Often this situation causes a problem at runtime because the Java class loader is limited such that the class loader only loads the class file if the class package name is known and if the prerequisite class of the class file is available to the class loader.

The present invention provides a mechanism to determine the class package name of a class file without dissembling the Java bytecodes. This type of determination is often a difficult and time-consuming task for a user or programmer. Further, disassembly or reverse engineering of bytecodes is against business conduct guidelines. In a preferred embodiment of the present invention, the dependent class files are not required to be available. The mechanism of the present invention can retrieve the class package name of a class file independently. In addition, the mechanism of the present invention does not require the source code of the class file, hence the .java file. The only requirement for the present invention, in the depicted examples, is that the class file has to be successfully compiled and must exist in the appropriate directory on the file system of the data processing system according to standard Java package naming convention.

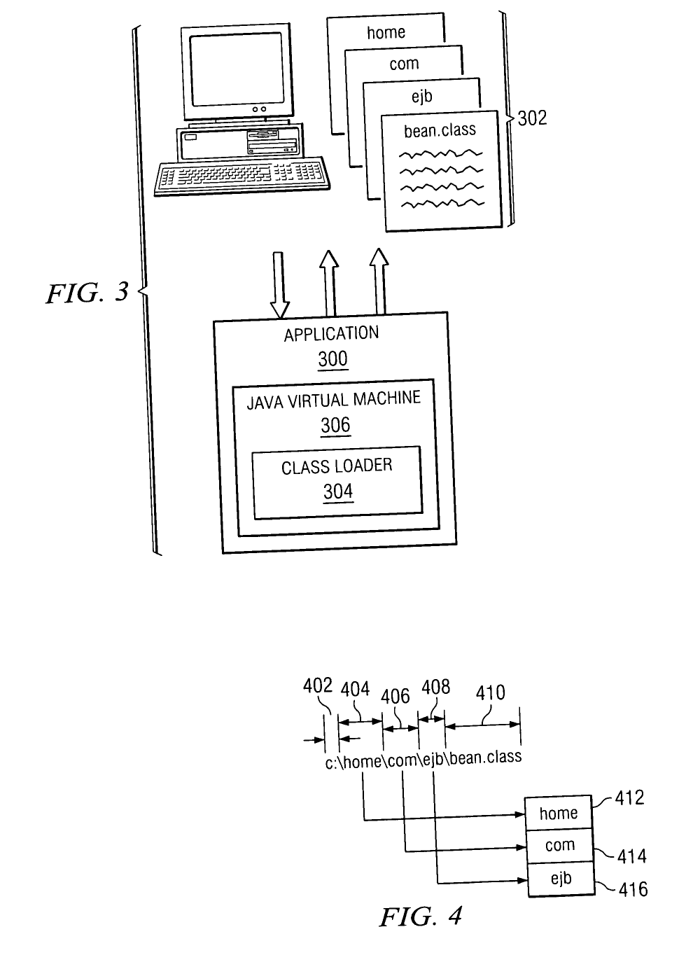

Turning now to FIG. 3, a diagram illustrating components used in identifying a class package name for a class file is depicted in accordance with a preferred embodiment of the present invention. As depicted in FIG. 3, when a user runs a particular Java application, such as application 300, the user may drag and drop the required class file, class file 302, into the application 300. In this example, class file 302 is a bean.class file. In this illustration, only the class file name for class file 302 is known by application 300 at this time.

Java class loader 304 within the Java virtual machine 306 attempts to load class file 302 when application 300 requires class file 302. However, in this illustration, Java class loader 304 is only able to load class file 302 by its package name, in this case com.ejb.Bean.class by using standard Java naming convention. As a result, application 300 throws a “NoClassDefFoundError” and application 300 exits. An example error message as shown below, identifies the class file that is not found by class loader 304/: java.lang.NoClassDefFoundError: com/ejb/bean
at com.ejb.Test.main(Test.java:16)
   Exception in thread “main”
   In this example, class loader 304 fails to load class file 302, named com.ejb.Bean.class, from the main method of the com.ejb.Test.class.

The mechanism of the present invention derives the correct package name for class loader 304 to load without requiring disassembly or reverse engineering of class file 302. The path for class file 302 is identified. In these examples, the path is the absolute path, which includes the directories all the way through the drive specification. The delimiters or separators for the different directory names and file name are used to parse this path into segments. Each segment includes a directory name or file name.

The correct package name is identified by iterating over the directory names to present class package names to Java virtual machine 306. When successful, class loader 304 is able to load the class or throws an exception stating that a requisite class is missing. In either case, this result indicates that the package name has been correctly identified. If the package name submitted to Java virtual machine 306 is incorrect, neither of these conditions exist.

This mechanism for iterating over segments in the path and presenting package names may be implemented within application 300 in FIG. 3 to identify the class package name.

Turning now to FIG. 4, a diagram illustrating a process used to parse a path for a class file into segments is depicted in accordance with a preferred embodiment of the present invention. As shown in FIG. 4, class path 400 contains segments 402, 404, 406, 408 and 410. In this example, the drive spec “c:” in segment 402 is discarded. By using the operating system's directory separator character, in this case a slash “\”, the next directory name “home” in segment 404 is obtained and stored within array 412 in element 414, which is the first element of array 412. The same process repeats for the next directory name “com” in segment 406 which is stored in the second element 416 array 412. Finally, “ejb” in segment 408 is stored in element 418. In this example, the last segment, segment 410, contains the class name itself, “Bean.class”. As a result, this name is not stored, but is used in each iteration for identifying the class package name.

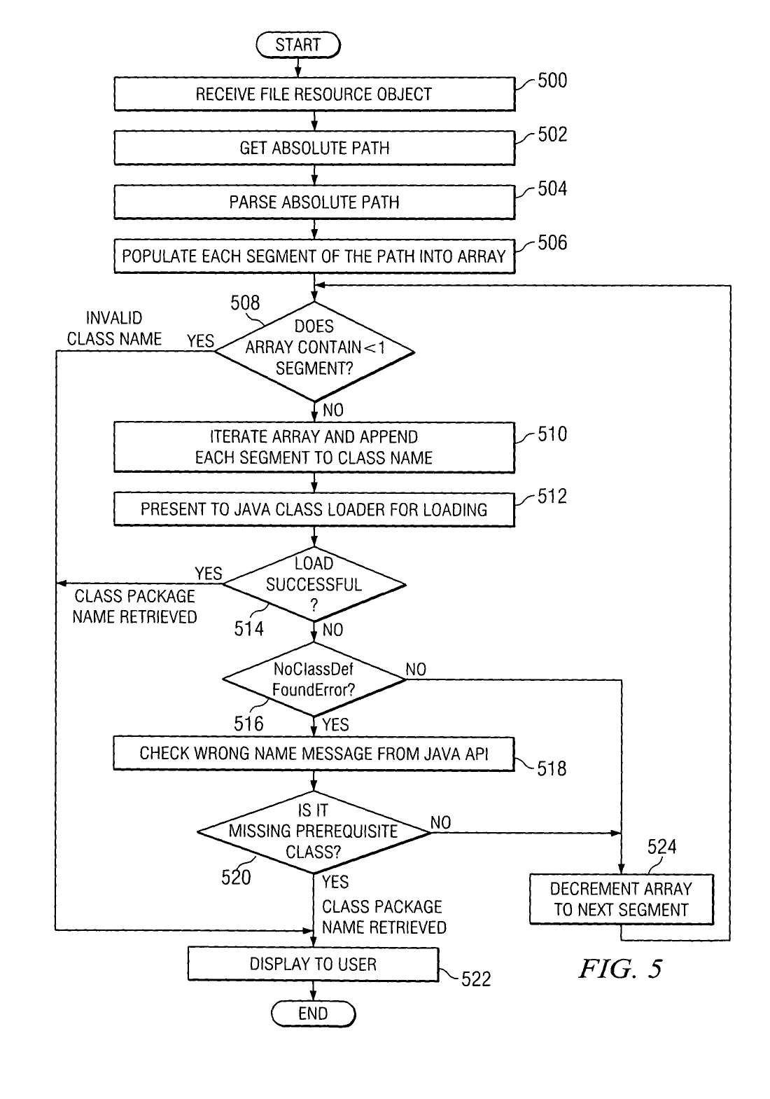

Turning next to FIG. 5, a flowchart of a process for identifying a class package name is depicted in accordance with a preferred embodiment of the present invention. The process illustrated in FIG. 5 may be implemented in a process in an application, such as application 300 in FIG. 3.

The process begins by receiving a class name selection (step 500). In response to this selection, the absolute path of the user class file is obtained (step 502). This path may be obtained from the operating system once the class name is received. For example, the following are class paths that may be obtained: c:\home\com\ejb\bean.class in Windows operating systems from Microsoft Corporation or /home/com/ejb/Bean.class in UNIX systems. Next, the path is parsed (step 504), and each segment of the path containing a directory name is placed into an array (506). In this example, the drive specification and the class name are not stored in the array.

Once the array is populated with segments from the path, a determination is made as to whether the number of total segments in the array is less than 1 (step 508). If the array contains more than one segment, the process iterates through the array and appends each segment to the class name (step 512). In step 512, the process starts with the highest number of elements N and appends a “.” character between each segment until the last segment. The last segment is appended with a “.” and the class name. The resulting string becomes the constructed class package name. For the example discussed above, the constructed class package name is home.com.ejb.Bean.class.

Once a class package name is constructed, this class package name is presented to the Java class loader to load the class (step 512). As described in FIG. 3, the class loader will attempt to load home.com.ejb.Bean.class. A determination is made as to whether the class is successfully loaded (step 514). A successful load occurs in the absence of a Java exception or error being thrown by the application.

If the class is not successfully loaded, a determination is made as to whether a “NoClassDefFoundError” is generated (step 516). If the Java class loader cannot load the class, the application will throw a “NoClassDefFoundError”. If this error is encountered, the process catches this error and an associated error message using a presently available Java API that identifies the error (step 518). The API that may be used to obtain associated error messages in this example is getMessage( ),

Next, the error message returned in step 518 is checked to see if the error message indicates whether a prerequisite class is missing (step 520). A prerequisite class is a class that is required to by the current class file before its own program can be executed. If a prerequisite class is missing, the constructed class package name is returned and presented to the user (step 522) with the process terminating thereafter. This presentation to the user may be made in these examples either through a user interface or command line display. Otherwise, the process decrements the index of the current array to N−1 (step 524). This step is performed to remove one of the segments from the array. The process then returns to step 508 as described above.

With reference again to step 516, if a “NoClassDefFoundError” is not returned, the process also proceeds to step 524 as described above. In step 514, if the loading of the class is successful, this class package name is sent to the user as described in step 522. With reference again to step 508, if the result is less than 1, a package is not associated with that class and the class package name is invalid.

Thus, the present invention solves the problem of the processing of a class file with an unknown class package name by the Java class loader in a JVM. In these examples, the mechanism of the present invention is located in an application. Other implementations are envisioned, such as in a default Java class loader or the bootstrap class loader. Such examples are presented for purposes of illustration and are meant to limit the way in which the present invention may be implemented. For example, the mechanism of the present invention may be implemented in other user-defined class loaders or applications. Further, this mechanism may be implemented in a separate application that is used to identify class package names during development of programs. A user-defined class loader is any class loader designed by the user that subclasses the ClassLoader object in the java.lang package of the Java API. The user-defined class loader can define its own implementation of class loading, for example, to load a class from an alternative resource.

In this manner, using the innovative features of the present invention, the user does not have to know the class package name of the class file to be loaded in the application. The user of the present invention also does not have to input the class package name himself. This mechanism helps to minimize the opportunity for error introduced by wrong inputs from the user. In addition, the present invention provides another advantage by reducing the time and effort required for retrieving the class package name of a class file. Without the need to dissemble the Java bytecodes of the user's software, which is a difficult and time-consuming task; the mechanism of the present invention enables the retrieval to be performed more dynamically and without the prerequisite class to be available.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A process in a data processing system for identifying package names, the process comprising the computer implemented steps of:
responsive to receiving a selection of a class file, identifying a path for a class file;
parsing the path to identify a set of sequential segments; and
ascertaining a package name for the class using the set of sequential segments, wherein the package name is ascertained without disassembling the class file.

2. The process of claim 1, wherein the class file is on a local file system.

3. The process of claim 1 further comprising:
receiving a selection of the class file, wherein the selection includes information sufficient to identifying the path for the class file.

4. The process of claim 1, wherein the parsing step includes:
identifying segments in the set of sequential segments using delimiters in the path.

5. The process of claim 1, wherein the ascertaining step includes:
selecting first segment containing a base class name to form a proposed package name;
submitting the proposed package name to a Java virtual machine;
responsive to the proposed package name being an incorrect name, prepending a next segment to the proposed package name; and
responsive to prepending the next segment, submitting the current package name to the Java virtual machine.

6. The process of claim 5, wherein the first segment is selected as being a first segment on a right side of the set of sequential segments.

7. The process of claim 1, wherein the process is located in a Java class loader.

8. The process of claim 1, wherein the class file is a Java class file.

9. A process in a data processing system for identifying a package name for a class file, the process comprising the computer implemented steps of:
receiving a selection of a class file;
identifying a path for the class file using the selection;
parsing the path to form an ordered set of segments;
selecting an unselected segment from the ordered set of segments;
adding the unselected segment to a set of selected segments;
generating a proposed package name using the set of selected segments;
submitting the proposed package name to a virtual machine for loading; and
repeating the selecting, adding, generating, and submitting steps in response to the proposed package name being an incorrect package name, wherein the package name is identified without examining code in the class file.

10. The process of claim 9, wherein the code is a set of bytecodes.

11. The process of claim 9, wherein the virtual machine is a Java virtual machine.

12. A data processing system for identifying package names, the data processing system comprising:
identifying means responsive to receiving means for receiving a selection of a class file, for identifying a path for a class file;
parsing means for parsing the path to identify a set of sequential segments; and
ascertaining means for ascertaining a package name for the class using the set of sequential segments, wherein the package name is ascertained without disassembling the class file.

13. The data processing system of claim 12, wherein the class file is on a local file system.

14. The data processing system of claim 12 further comprising:
receiving means for receiving a selection of the class file, wherein the selection includes information sufficient to identifying the path for the class file.

15. The data processing system of claim 12, wherein the identifying means is a first identifying means and wherein the parsing means includes:
second identifying means for identifying segments in the set of sequential segments using delimiters in the path.

16. The data processing system of claim 12, wherein the ascertaining means includes:
selecting means for selecting first segment containing a base class name to form a proposed package name;
first submitting means for submitting the proposed package name to a Java virtual machine;
prepending means, responsive to the proposed package name being an incorrect name, for prepending a next segment to the proposed package name; and
second submitting means responsive to prepending the next segment, for submitting the current package name to the Java virtual machine.

17. The data processing system of claim 16, wherein the first segment is selected as being a first segment on a right side of the set of sequential segments.

18. The data processing system of claim 12, wherein the process is located in a Java class loader.

19. The data processing system of claim 12, wherein the class file is a Java class file.

20. A process in a data processing system for identifying a package name for a class file, the data processing system comprising:
receiving means for receiving a selection of a class file;
identifying means for identifying a path for the class file using the selection;
parsing means for parsing the path to form an ordered set of segments;
selecting means for selecting an unselected segment from the ordered set of segments;
adding means for adding the unselected segment to a set of selected segments;
generating means for generating a proposed package name using the set of selected segments;
submitting means for submitting the proposed package name to a virtual machine for loading; and
repeating means for repeating initiation of the selecting means, adding means, generating means, and submitting means in response to the proposed package name being an incorrect package name, wherein a package name is identified without examining code in the class file.

21. The data processing system of claim 20, wherein the code is a set of bytecodes.

22. The data processing system of claim 20, wherein the virtual machine is a Java virtual machine.

23. A computer program product in a computer readable medium for identifying package names, the computer program product comprising:
first instructions responsive to receiving a selection of a class file, for identifying a path for a class file;
second instructions for parsing the path to identify a set of sequential segments; and
third instructions for ascertaining a package name for the class using the set of sequential segments, wherein the package name is ascertained without disassembling the class file.

24. The computer program product of claim 23, wherein the class file is on a local file system.

25. The computer program product of claim 23 further comprising:
fourth instructions for receiving a selection of the class file, wherein the selection includes information sufficient to identifying the path for the class file.

26. The computer program product of claim 23, wherein the second instructions includes:
sub-instructions for identifying segments in the set of sequential segments using delimiters in the path.

27. The computer program product of claim 23, wherein the third instructions includes:
first sub-instructions for selecting first segment containing a base class name to form a proposed package name;
second sub-instructions for submitting the proposed package name to a Java virtual machine;
third sub-instructions for responsive to the proposed package name being an incorrect name, prepending a next segment to the proposed package name; and
fourth sub-instructions for responsive prepending the next segment submitting the current package name to the Java virtual machine.

28. The computer program product of claim 27, wherein the first segment is selected as being a first segment on a right side of the set of sequential segments.

29. The computer program product of claim 23, wherein the process is located in a Java class loader.

30. The computer program product of claim 23, wherein the class file is a Java class file.

31. A computer program product in a computer readable medium for identifying a package name for a class file, the computer:
first instructions for receiving a selection of a class file;
second instructions for identifying a path for the class file using the selection;
third instructions for parsing the path to form an ordered set of segments;
fourth instructions for selecting an unselected segment from the ordered set of segments;
fifth instructions for adding the unselected segment to a set of selected segments;
sixth instructions for generating a proposed package name using the set of selected segments;
seventh instructions for submitting the proposed package name to a virtual machine for loading; and
eighth instructions for repeating the initiation of fourth, fifth, sixth, and seventh instructions in response to the proposed package name being an incorrect package name, wherein a package name is identified without examining code in the class file.

32. The computer program product of claim 31, wherein the code is a set of bytecodes.

33. The computer program product of claim 31, wherein the virtual machine is a Java virtual machine.

34. A data processing system comprising:
a bus system;
a memory connected to the bus system, wherein the memory includes a set of instructions; and
a processing unit connected to the bus system, wherein the processing unit executes a set of instructions to identify a path for a class file in response to receiving a selection of the class file; to parse the path to identify a set of sequential segments;
and to ascertain a package name for the class using the set of sequential segments, wherein the package name is ascertained without disassembling the class file.

35. A data processing system comprising:
a bus system;
a memory connected to the bus system, wherein the memory includes a set of instructions; and
a processing unit connected to the bus system, wherein the processing unit executes a set of instructions to receive a selection of a class file; identify a path for the class file using the selection; parse the path to form an ordered set of segments; select an unselected segment from the ordered set of segments; add the unselected segment to a set of selected segments; generate a proposed package name using the set of selected segments; submit the proposed package name to a virtual machine for loading; and repeat instructions to select, add, generate, and submit in response to the proposed package name being an incorrect package name, wherein the package name is identified without examining code in the class file.
